(19) United States
(12) Patent Application Publication
(10) Pub. No.: US 2016/0063580 A1
(43) Pub. Date: Mar. 3, 2016

(54) System, apparatus, and method for template-based adaptive review

(71) Applicant: Gersse LLC, New York, NY (US)

(72) Inventors: Jesse M. Greenberg, New York, NY (US); Matthew R. Gerson, Jericho, NY (US); Andrew M. Katz, Dix Hills, NY (US)

(21) Appl. No.: 14/469,541

(22) Filed: Aug. 26, 2014

(51) Int. Cl. G06Q 30/02

(52) U.S. Cl. CPC G06Q 30/0282

(57) ABSTRACT

A system for template-based adaptive review includes an adaptive review server, further including a processor, a non-transitory memory, an input/output, a review engine, and a review template store; and an adaptive review device, further including a processor, a non-transitory memory, an input/output, a review controller, and a review store; such that the adaptive review device can retrieve a list of review templates from the review template store, and a user can select and fill out the review template by providing check box, dropdown list, text and numeric user inputs to a set of review sentences associated with the review template, whereby a user review is completed. Also disclosed is a method for template-based adaptive review, including selecting a review template, selecting a review sentence, viewing the review sentence, providing user input, and repeating until all review sentences have been selected, whereby the review is completed.

### CROSS-REFERENCE TO RELATED APPLICATIONS

N/A

### FIELD OF THE INVENTION

The present invention relates generally to the field of online reviews for products, services, and establishments, and more particularly to methods and systems for providing content guidance or direction for completing a review.

### BACKGROUND OF THE INVENTION

A customer review is a review of a product or service made by a customer, who has purchased the product or service, or is in some other capacity familiar with the product or service. Customer reviews serve as a form of customer feedback, and are particularly common on electronic commerce and online shopping sites. Amazon.com is, for example, well known for providing extensive review functionality for products that are offered for sale on the website. There are also dedicated review sites such as, for example, Yelp! and TripAdvisor.

On traditional review sites, reviews and comments are generally user controlled and therefore wide ranging in focus and scope. A user is tasked with word development, sentence structure, tone, and grammar. As result, these tasks can make a review both time consuming for the reviewer, and often uninformative or ineffective to the reader. This may not only discourage many people from writing reviews, but often limits the value of reviews to another reader.

As such, considering the foregoing, it may be appreciated that there continues to be a need for novel and improved systems, devices, and methods for writing and managing customer reviews.

### SUMMARY OF THE INVENTION

The foregoing needs are met, to a great extent, by the present invention wherein, in aspects of this invention, enhancements are provided to the existing model of customer reviews.

In an aspect, a method for template-based adaptive review is a data collection method designed to guide users through the review process with maximum ease and minimal investment. This is done by limiting the entry into the template-based adaptive review to identified, value-add entry fields. The result is a well-formed, informative paragraph that accurately describes the author's experience and provides a valuable account of the experience to another reader.

In an aspect, a system for template-based adaptive review can include:
a) An adaptive review server; and
b) An adaptive review device;
wherein the adaptive review device can retrieve a list of review templates from the adaptive review server, such that a user can select a review template, after which the user is presented with a sequence of review sentences, selected from a set of review sentences, such that each review sentence will have one or more inputs, typically in the form of checkbox, dropdown, text or numeric fields, and the review is completed when the user has filled out input for all review sentences.

In related aspects, the user can step through the review sentences one by one, or alternatively the sentences can be presented in one overview, so that the user can step through the sentences, thereby completing the user review.

In various related aspects, the adaptive review device can include configurations executing as a browser based web application, as a tablet app or mobile app, as a desktop application, or as an application executing on some other form of processing device.

There has thus been outlined, rather broadly, certain embodiments of the invention in order that the detailed description herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described, and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram illustrating a system for template-based adaptive review, according to an embodiment of the invention.

FIG. 2 is a schematic diagram illustrating an adaptive review server, according to an embodiment of the invention.

FIG. 3 is a schematic diagram illustrating an adaptive review device, according to an embodiment of the invention.

FIG. 4 is a schematic diagram illustrating a sequence diagram for interactions of a system for template-based adaptive review, according to an embodiment of the invention.

FIG. 5 is an illustration of an adaptive review graphical user interface, according to an embodiment of the invention.

FIG. 6 is an illustration of an adaptive review graphical user interface, according to an embodiment of the invention.

FIG. 7 is an illustration of an adaptive review graphical user interface, according to an embodiment of the invention.

FIG. 8 is a flowchart illustrating steps that may be followed, in accordance with one embodiment of a method or process of template-based adaptive review.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

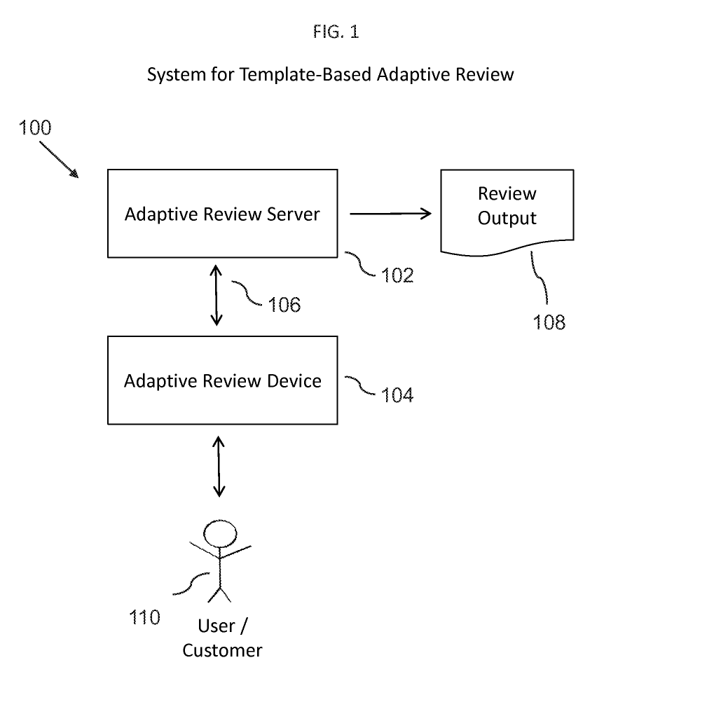

In the following, is described the structure of an embodiment of a system for template-based adaptive review 100 with reference to FIG. 1, in such manner that like reference numerals refer to like components throughout; a convention that shall be employed for the remainder of this specification.

In an embodiment a system for template-based adaptive review 100 can comprise:
c) An adaptive review server 102; and
d) An adaptive review device 104;
wherein the adaptive review device 104 is connected to the adaptive review server 102 via a network 106, such that the adaptive review device 104 can retrieve a list of review templates from the adaptive review server 102, such that a user 110 can select a review template from the adaptive review device 104, after which the user 110 is presented a sequence of review sentences, selected from a set of review sentences that are associated with the review template, such that each sentence will have at least one review input, typically in the form of checkbox, dropdown, text or numeric fields, or another form of common GUI control or input, such that upon receiving the review input in a first sentence , the adaptive review device can determine the next following second sentence, until all sentences have been completed, thereby completing the review associated with the selected review template.

In a related embodiment, the system for template-based adaptive review 100 can further produce a review output 108, which can, for example, be a document or a web page, containing a description of a completed review.

In a related embodiment, a review can be comprised of a list of review sentences. A review sentence can include a textual communication, and can further include at least one review input. A review input can be a checkbox, a dropdown menu, text or numeric fields, or another form of common GUI control or input. A review template is a review that has not been filled out with user input. A completed review is a review template wherein all review inputs have been filled out by a user.

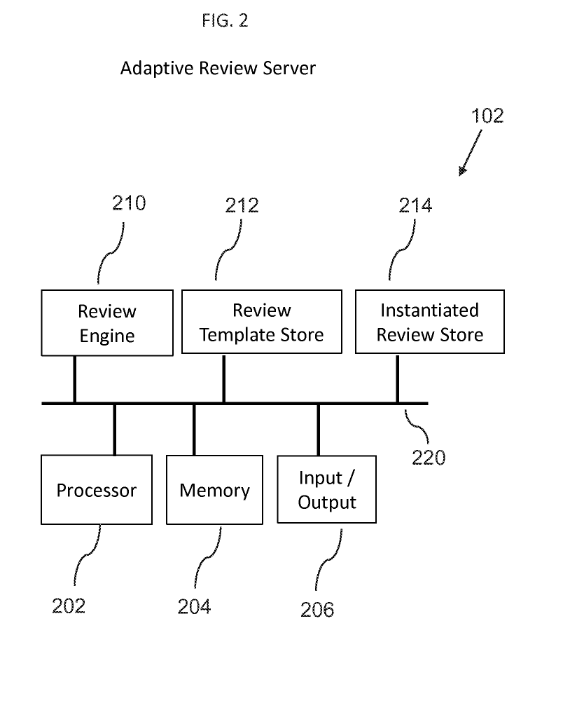

In a related embodiment, as illustrated in FIG. 2, an adaptive review server 102 can be comprised of:
a. A processor 202;
b. A non-transitory memory 204;
c. An input/output component 206;
d. A review engine 210;
e. A review template store 212;
f. An instantiated review store 214; all connected via
g. A data bus 220;
Wherein the review template store 212 stores review templates and associated review sentences, and the review engine 210 can retrieve the review templates and process sentences from the review template store 212, and the review engine 210 can store a completed review, with review sentences and user inputs, in the instantiated review store 214.

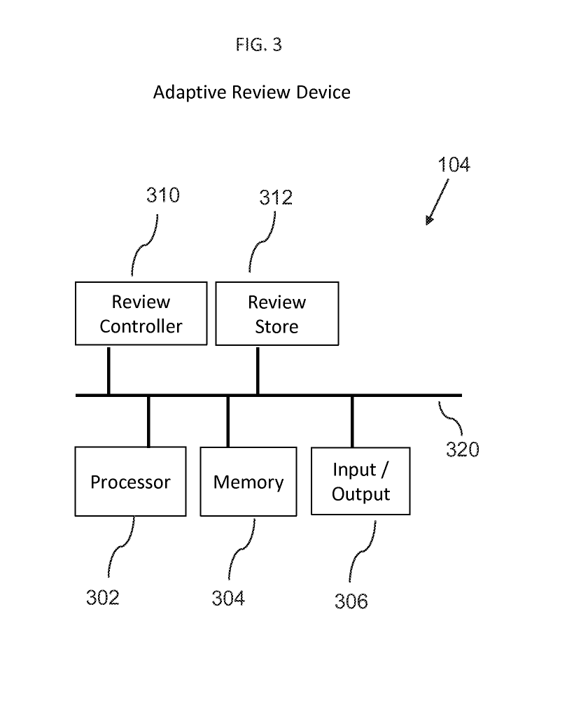

In a related embodiment, as illustrated in FIG. 3, an adaptive review device 104 can be comprised of:
a. A processor 302;
b. A non-transitory memory 304;
c. An input/output 306;
d. A review controller 310; and
e. A review store 312; all connected via
f. A data bus 320;
Wherein the review controller 310 can receive a review template in communication via a network 106 with the adaptive review server 102, and further the review controller 310 can present review sentences of the review template to a user for providing review input via the input/output 306, such that the review template with user input is stored in the review store 312.

In related example embodiments, the adaptive review device 104 can include configurations as:
a. A web application, executing in a Web browser;
b. A tablet app, executing on a tablet device, such as, for example, an Android or iOS tablet device;
c. A mobile app, executing on a mobile device, such as, for example, an Android phone or iPhone, or any wearable mobile device;
d. A desktop application, executing on a personal computer, or similar device; or
e. An embedded application, executing on a processing device, such as, for example, a smart TV, a game console, or other system.

It shall be understood that an executing instance of an embodiment of the system for template-based adaptive review 100, as shown in FIG. 1, can include a plurality of adaptive review devices 104, which are each tied to one or more users 110.

An executing instance of an embodiment of the system for template-based adaptive review 100, as shown in FIG. 1, can similarly include a plurality of adaptive review servers 102.

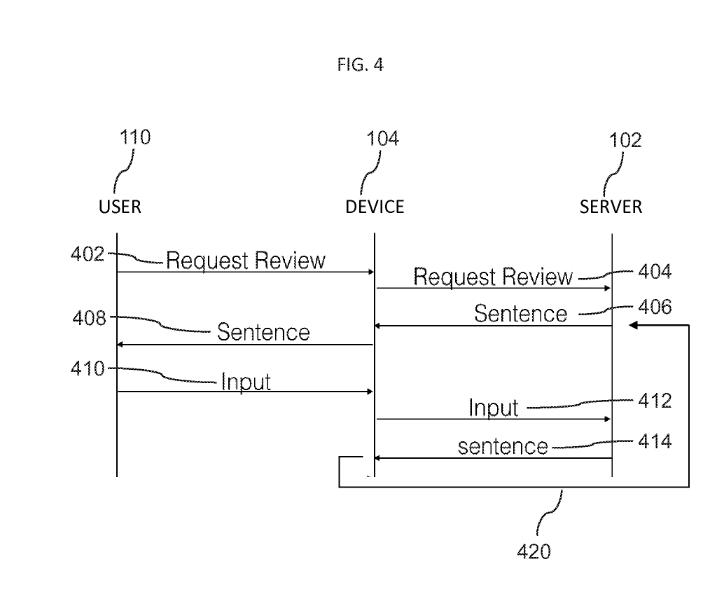

In a related embodiment, FIG. 4 illustrates a sequence diagram for interactions between the user 110, the adaptive review device 104, and the adaptive review server 102, such that a sequence of interactions can comprise:
a) The user 110 requests a review template 402 via the review engine 210 of the adaptive review device 104;
b) The review controller 310 of the adaptive review device 104 requests a review template 404 from the adaptive review server 102;
c) The adaptive review server 102 sends a sentence template 406 back to the adaptive review device 104;
d) The user 110 receives the sentence template 408, which is displayed by the adaptive review device 104;
e) The user provides input 410 for the sentence template via the review controller 310 of the adaptive review device 104;
f) The user input 412 is sent from the review controller 310 of the adaptive review device 104 to the review engine 210 of the adaptive review server 102, which instantiates the sentence template to produce a instantiated review sentence 414, which is stored by the review engine 210 in the instantiated review store 214;
g) The process repeats 420 steps c)-f) until all sentences have been processed; and
h) The completed instantiated review is stored in the instantiated review store 214 of the adaptive review server 102.

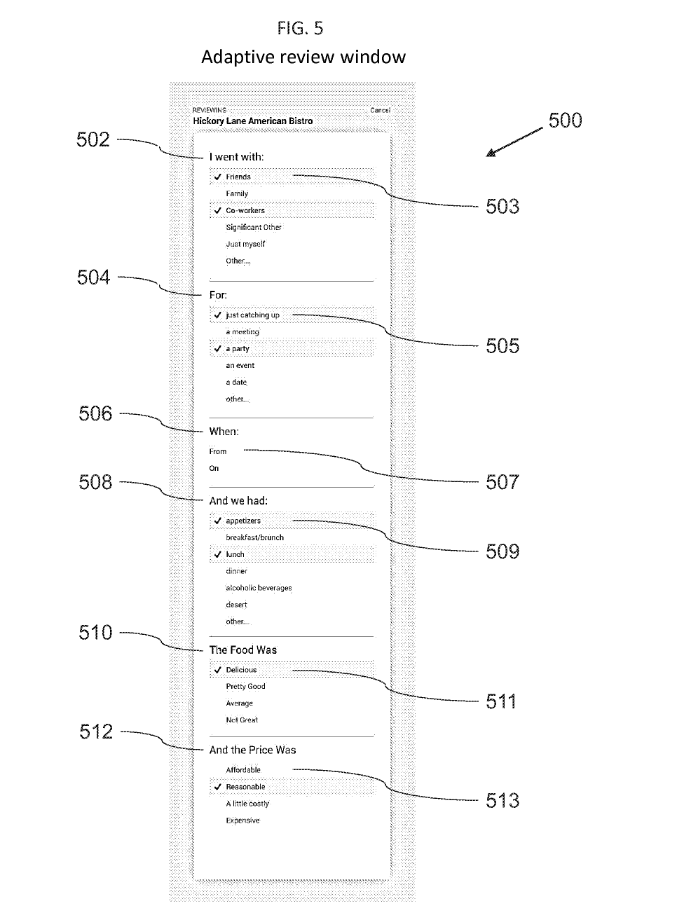

In a related example embodiment, FIG. 5 shows an adaptive review window 500 associated with the GUI for the adaptive review device 104, including sentences:
a) A participant selection sentence 502, including a participant selection check-list 503;
b) An activity type selection sentence 504, including an activity type selection check-list 505;
c) A date and time selection sentence 506, including a from/to date/time input 507;
d) A meal type selection sentence 508, including a meal type selection check-list 509;
e) A food rating sentence 510, including a food rating selection check-list 511; and
f) A price rating sentence 512, including a pricing rating selection check-list 513;
Such that the adaptive review window 500 shows a review in process, wherein the user 110 has just provided input for a price rating sentence 512, after which the adaptive review device 104 will append a next review sentence, which, for example, can be a next input sentence, such as a conclusion input, or it can be a review completion event, providing confirmation to the user 110 that the review has been completed.

In further related embodiments, the user input can include:
a. Free form text;
b. A number;
c. A numeric value;
d. A timestamp or time range;
e. A check-mark selection list, such that one or more items on a list can be selected;
f. A drop down box such that one item can be selected from a drop down list; or
g. Other common graphical user interface input controls.

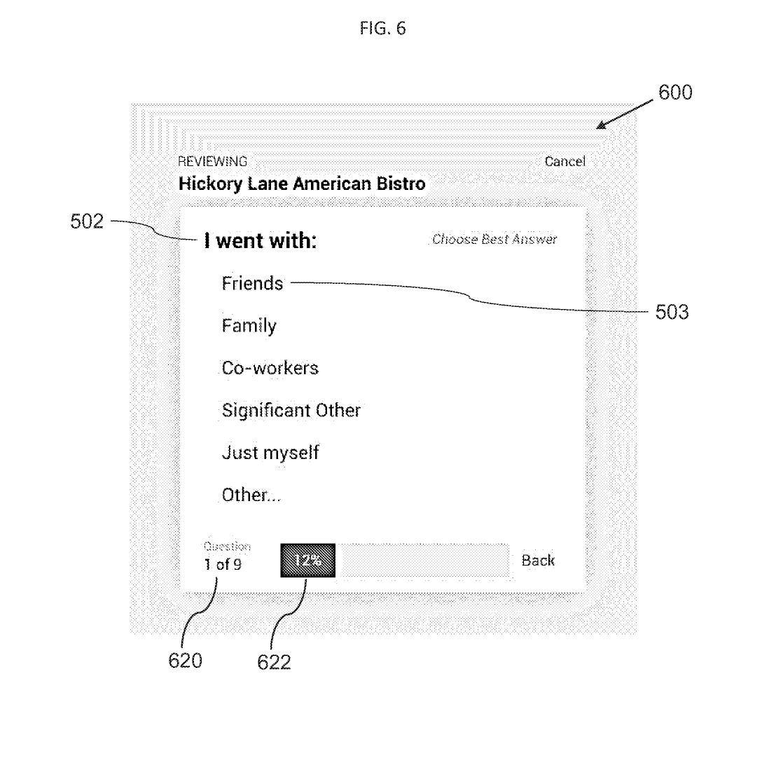

In an alternative example embodiment, FIG. 6 shows an adaptive review window 600 associated with the graphical user interface provided by the review controller 310 of the adaptive review device 104, showing a review in process, and displaying only the current review sentence, which in this example is the participant selection sentence 502, including the participant selection check-list 503, sentence number progress indicator 620, and a percentage completed progress indicator 622. The adaptive review window 600 shows the review in a state before the user has selected an input for the participant selection sentence 502.

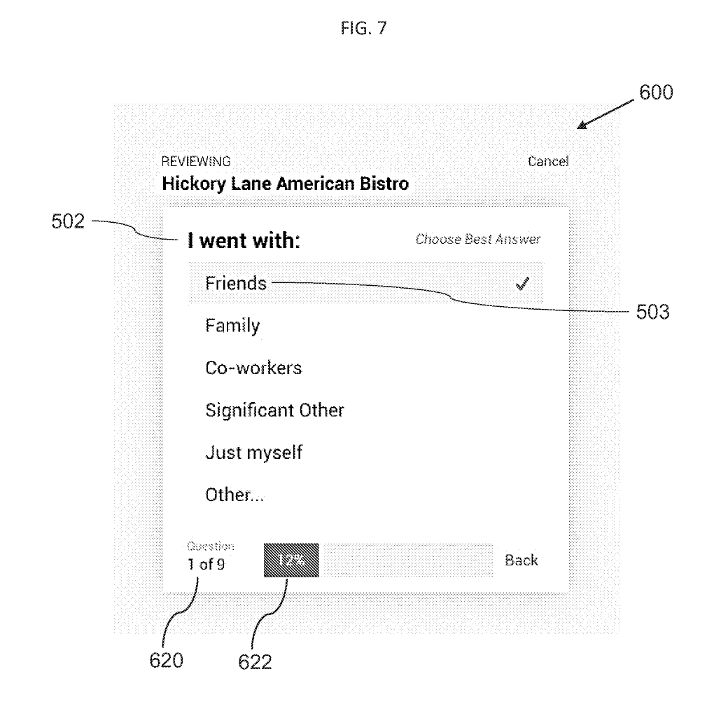

FIG. 7 shows the adaptive review window 600 in a state after the user 110 has selected an input 503 from a list of possible values for the participant selection sentence 502, indicating that the user went with friends.

In various embodiments, as illustrated in FIGS. 5, 6, and 7, the review controller 310 of the adaptive review device 104, can be configured to:
a. Present review sentences of the review template in a single overview, as shown in FIG. 5, such that the user steps through each review sentence as a part of the single overview; or
b. Present review sentences of the review template separately one-by-one, as shown in FIGS. 6 and 7, such that, for example, the user is providing the input selection associated with a particular review sentence, and information on how far the overall review is progressed.

In some embodiments, review templates and associated review sentences can be hard-coded in the particular source language of a programming environment, such that user input selections are stored in memory 204 304 with reference to the review template, thereby result in an instantiated user review when user input has been provided for all review sentences associated with a review template.

In other embodiments, review templates and associated review sentences can be described in a specification language, including:
a. XML or variants of XML;
b. Other markup languages;
c. Script and object notation languages, such as JSON;
d. Context free grammar definition languages, which can include input control descriptors, and can describe recursive language structures; or
e. Other marshalled data formats.

In a related embodiment, each review sentence in the sequence of review sentences can be a conditional review sentence, such that it is only presented if a logical expression is true, such that the logical expression can be based on user input from previous review sentences and/or other context and environment variables. For example, if a user input indicates that the user had a meal; a following review sentence related to food, which is conditional to a meal user input, can be presented.

In a related embodiment, review sentences can be configured as a directed graph, wherein each review sentence is a parent node in the directed graph, and a logical case expression, associated with the parent node, directs which children nodes are connected to the parent node. A root node is the starting point for a review, and a sequence of review sentences is selected by a traversal of the directed graph, from the root node to a terminating node, which is an ending review sentence. A traversal of the directed graph from a root to an ending node, is thereby the result of a dynamic and adaptive process, with a specific review resulting from a sequence of case expression decisions, which derives a review as a path from the root to the ending node.

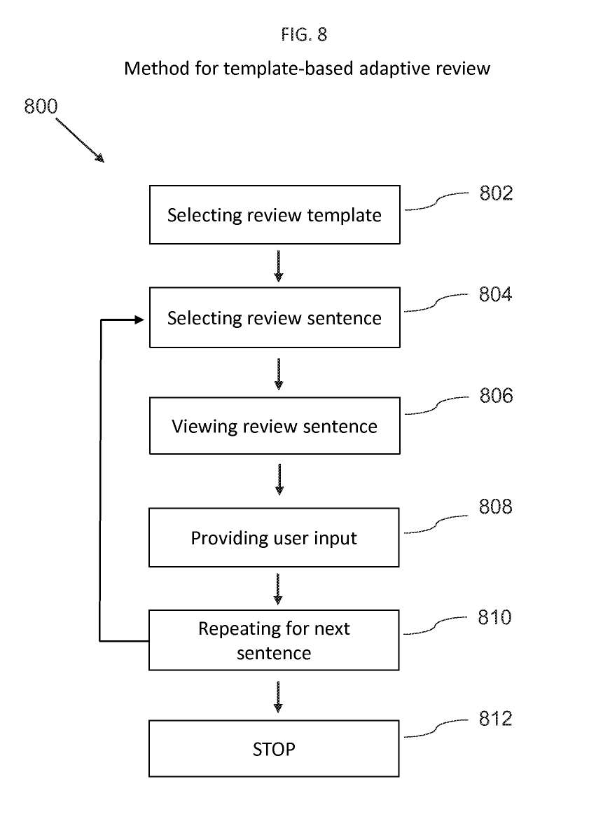

In an embodiment, as illustrated in FIG. 8, a computer-based method for template-based adaptive review 800, can include:
a. Selecting a review template 802, wherein the review template is selected by a user 110 from a list of review templates;
b. Selecting a review sentence 804, such that the review sentence is selected by the server 102 from a set of review sentences associated with the selected review template;
c. Viewing the review sentence 806, wherein the user views the review sentence 408;
d. Providing user input 808, wherein the user provides input for input selections of the review sentence 410; and
e. Repeating steps b.-d. 810 until all review sentences in the set of review sentences have been selected 420.

FIGS. 1, 2, 3 and 4 are block diagrams and flowcharts to demonstrate methods, devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

In this regard, FIGS. 1, 2, and 3 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include various forms of non-transitory storage media such as random access memory (RAM) and read-only memory (ROM). The computer also may include nonvolatile storage memory, such as a hard disk drive, where additional data can be stored.

FIG. 1 shows a depiction of an embodiment of the system for template-based adaptive review 100, including the adaptive review server 102, and the adaptive review device 104. In this relation, a server shall be understood to represent a general computing capability that can be physically manifested as one, two, or a plurality of individual physical computing devices, located at one or several physical locations. A server can, for example, be manifested as a shared computational use of one single desktop computer, a dedicated server, a cluster of rack-mounted physical servers, a datacenter, or network of datacenters, each such datacenter containing a plurality of physical servers, or a computing cloud, such as Amazon EC2 or Microsoft Azure.

It shall be understood that the above-mentioned components of the adaptive review server 102 and the adaptive review device 104 are to be interpreted in the most general manner.

For example, the processors 202 302 can each respectively include a single physical microprocessor or microcontroller, a cluster of processors, a datacenter or a cluster of datacenters, a computing cloud service, and the like.

In a further example, the non-transitory memory 204 304 can each respectively include various forms of non-transitory storage media, including RAM, other forms of dynamic storage, and various forms of long-term storage, including hard disks, hard disk clusters, and cloud storage services. Similarly, the input/output 206 306 can each respectively include a plurality of well-known input/output devices, such as screens, keyboards, pointing devices, motion trackers, communication ports, and so forth.

Furthermore, it shall be understood that the adaptive review server 102 and the adaptive review device 104 can each respectively include a number of other components that are well known in the art of general computer devices, and therefore shall not be further described herein. This can include system access to common functions and hardware, such as, for example, via operating system layers such as Windows, Linux, and similar operating system software, but can also include configurations wherein application services are executing directly on server hardware or via a hardware abstraction layer other than a complete operating system.

An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) or wide area network (WAN), and can include all of the necessary circuitry for such a connection.

In a related embodiment, the adaptive review device 104 communicates with the adaptive review server 102 over a network 106, which can include the general Internet, a WAN or a LAN, or another form of communication network, transmitted on wired or wireless connections. Wireless networks can, for example, include Ethernet, Wi-Fi, Bluetooth, ZigBee, cellular, and NFC. The communication can be transferred via a secure, encrypted communication protocol.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart, or control flow illustrations support combinations of means for performing the specified functions, combinations of steps for performing the specified functions, and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

The many features and advantages of the invention are apparent from the detailed specification, and thus, it is intended by the appended claims to cover all such features and advantages of the invention, which fall within the true spirit and scope of the invention.

For example, alternative embodiments can reconfigure or combine the components of the adaptive review server 102 and the adaptive review device 104. The components of the adaptive review server 102 can be distributed over a plurality of physical, logical, or virtual servers. Parts or all of the components of the adaptive review device 104 can be configured to operate in the adaptive review server 102, whereby the adaptive review device 104, for example, can function as a thin client, performing only graphical user interface presentation and input/output functions. Alternatively, parts or all of the components of the adaptive review server 102 can be configured to operate in the adaptive review device 104.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A system for template-based adaptive review, comprising:
a. an adaptive review server; and
b. an adaptive review device;
wherein the adaptive review device is connected to the adaptive review server via a network, such that the adaptive review device is configured to retrieve a list of review templates from the adaptive review server, such that a user selects a review template, which includes a set of review sentences, such that each review sentence further comprises at least one user input, such that upon receiving the user input for a first review sentence from the set of review sentences, the adaptive review device is configured to determine a next following second review sentence, until all review sentences are completed, thereby completing a user review associated with the selected review template.

2. The system for template-based adaptive review of claim 1, wherein the adaptive review server further comprises:
a. a processor;
b. a non-transitory memory;
c. an input/output component; and
d. a review engine;
wherein the review engine is configured to retrieve, process, transmit, and store review templates, including associated sets of review sentences and user input, in communication with the non-transitory memory.

3. The system for template-based adaptive review of claim 2, wherein the adaptive review server further comprises a review template store, such that the review template store contains the review templates and the associated sets of review sentences, and the review engine retrieves and stores the review templates and the associated sets of review sentences in communication with the review template store.

4. The system for template-based adaptive review of claim 2, wherein the adaptive review server further comprises an instantiated review store, such that the review engine is configured to store a completed review, including completed review sentences and completed user inputs, in the instantiated review store.

5. The system for template-based adaptive review of claim 1, wherein the adaptive review device further comprises:
a. a processor;
b. a non-transitory memory;
c. an input/output; and
d. a review controller;
wherein the review controller is configured to receive the review template in communication with the adaptive review server, and further the review controller is configured to present the set of review sentences of the review template via the input/output to a user, that provides review input via the input/output.

6. The system for template-based adaptive review of claim 5, wherein the adaptive review device further comprises a review store, such that the review template with the review input is stored in the review store.

7. The system for template-based adaptive review of claim 5, wherein the review controller is configured to present the set of review sentences of the review template in a single overview, such that the user steps through each review sentence as a part of the single overview.

8. The system for template-based adaptive review of claim 5, wherein the review controller is configured to present the set of review sentences of the review template separately one-by-one.

9. The system for template-based adaptive review of claim 1, wherein the list of review templates, the selected review template, and the set of review sentences are described in a specification language.

10. The system for template-based adaptive review of claim 9, wherein the specification language is XML.

11. The system for template-based adaptive review of claim 9, wherein the specification language is JSON.

12. The system for template-based adaptive review of claim 1, wherein the set of review sentences is configured as a sequence of review sentences, such that at least one review sentence in the sequence of review sentences, is a conditional review sentence.

13. The system for template-based adaptive review of claim 1, wherein the set of review sentences is configured as a directed graph, such that each review sentence is a node in the directed graph, wherein a logical case expression, associated with a parent node, directs which children nodes are connected to the parent node.

14. An adaptive review device, comprising:
a. a processor;
b. a non-transitory memory;
c. an input/output; and
d. a review controller;
wherein the adaptive review device is connected to an adaptive review server via a network, such that the adaptive review device is configured to retrieve a list of review templates from the adaptive review server, such that a user selects a review template, which includes a set of review sentences, such that each review sentence further comprises at least one user input, such that upon receiving the user input for a first review sentence from the set of review sentences, the adaptive review device is configured to determine a next following second review sentence, until all sentences are completed, thereby completing a user review associated with the selected review template.

15. The adaptive review device of claim 14, wherein the adaptive review device further comprises a review store, such that the review template with review input is stored in the review store.

16. The adaptive review device of claim 14, wherein the review controller is configured to present the set of review sentences of the review template in a single overview, such that the user steps through each review sentence as a part of the single overview.

17. The adaptive review device of claim 14, wherein the list of review templates, the selected review template, and the set of review sentences are defined in a specification language.

18. The adaptive review device of claim 17, wherein the specification language is JSON.

19. A computer-based method for template-based adaptive review, comprising:
a. selecting a review template, wherein the review template is selected by a user from a list of review templates; and
b. completing the review, wherein a user fills out input selections of the review template.

20. The computer-based method for template-based adaptive review of claim 19, wherein the act of completing the review further comprises:
i. selecting a review sentence, such that the review sentence is selected from a set of review sentences of the selected review template;
ii. viewing the review sentence, wherein the user views the review sentence;
iii. providing user input, wherein the user provides input for input selections of the review sentence, thereby instantiating the review sentence; and
iv. repeating steps i.-iii. until all review sentences in the set of review sentences have been selected, whereby the user review is instantiated and completed.

21. The computer-based method for template-based adaptive review of claim 20, wherein the list of review templates, the selected review template, and the set of review sentences are described in a specification language.

22. The computer-based method for template-based adaptive review of claim 21, wherein the specification language is JSON.

23. The computer-based method for template-based adaptive review of claim 20, wherein the set of review sentences is configured as a sequence of review sentences, such that at least one review sentence in the sequence of review sentences, is a conditional review sentence.

24. The computer-based method for template-based adaptive review of claim 20, wherein the set of review sentences is configured as a directed graph, such that each review sentence is a node in the directed graph, wherein a logical case expression, associated with a parent node, directs which children nodes are connected to the parent node.
